(19) United States
(12) Patent Application Publication
(10) Pub. No.: US 2004/0196601 A1
(43) Pub. Date: Oct. 7, 2004

(54) Electrostatic discharge protecting circuit using flash cell

(75) Inventor: Keon Soo Shim, Kyungki-Do (KR)

Correspondence Address: MARSHALL, GERSTEIN & BORUN LLP, 6300 SEARS TOWER, 233 S. WACKER DRIVE, CHICAGO, IL, 60606, US

(73) Assignee: HYNIX SEMICONDUCTOR INC., Kyungki-Do (KR)

(21) Appl. No.: 10/738,871

(22) Filed: Dec. 17, 2003

(30) Foreign Application Priority Data
Apr. 3, 2003 (KR) 2003-21060

(51) Int. Cl. H02H 9/00

(52) U.S. Cl. 361/56

(57) ABSTRACT

The disclosed is an electrostatic discharge protecting circuit using a flash cell, comprising: a plurality of flash cells connected between an I/O pad and a VSS line, a gate of each flash cell being connected to the I/O pad; and a resistor connected between a floating gate of each flash cell and the VSS line.

### BACKGROUND

1. Field of the Invention

The present invention relates to an electrostatic discharge protecting circuit using a flash cell and, more particularly, to an electrostatic discharge protecting circuit using a flash cell capable of improving device reliability by obtaining a high ESD level.

2. Discussion of Related Art

The electrostatic discharge (hereinafter, referred to as “ESD”) has been known as one of the prime reasons of device failures such as device characteristic deterioration originated by hot carriers, electro-migration, time-dependent dielectric breakdown (TDDB), and soft errors originated by α-ray. Most of all, the ESD has a highest position in the reasons of failures of the integrated circuits because it breaks down the integrated circuits at a brief instant. Furthermore, the ESD occurs at any instant from the process initiation of a wafer level to the customer's handling.

In addition, as the junction depth of an impurity layer and the thickness of a gate insulation film in an MOS transistor are getting smaller and smaller along with the tendency to device minimization, influence of the ESD on the reliability of next generation integrated circuit is expected to increase.

From the viewpoint of a chip design, a protecting circuit disposed between an I/O terminal and a power line has been known as the most effective means to prevent influence of the over-voltage and over-current generated by the ESD on the internal circuits. Currently, since the most available unit device for recent integrated circuits is a MOS transistor, the specification of a MOS transistor has been important in a CMOS logic circuit or an analog circuit. Particularly, in the MOS transistor used for preventing the ESD, which is required to have a high current-driving capability, a higher width of gate terminal is preferable. For this reason, a finger type MOS transistor has been used.

FIG. 1 shows a conventional electrostatic discharge protecting circuit, in which an NMOS transistor is connected between the I/O terminal and the VSS line, as described above.

FIG. 2 is a layout showing a conventional electrostatic discharge-protecting circuit comprising finger type MOS transistors. The reference numerals, 10, 20, and 30 indicate a gate area, a junction area, and a contact area, respectively. With respect to the gate area 10, the left junction area 20 is set to the source area, and the right is set to the drain area. Each drain area is directly connected to the I/O pad 40, whereas each source area is connected to the VSS line 50.

In a conventional electrostatic discharge protecting circuit comprising finger type transistors, a plurality of gate areas 10 are disposed in the shape of finger, and the source and drain areas are disposed on both sides of the gate areas 10.

In such a finger type electrostatic discharge protecting circuit, when the drain of the NMOS transistor is directly connected to the I/O pad and a high external bias is applied thereto, snapback phenomena occur in a voltage of Vt1, as shown in FIG. 3, so that the drain voltage can drops to Vsb. If the external bias by the ESD is continuously applied, the drain voltage and current are increased up to Vt2 and It2, respectively. If the increased drain current cannot decrease the drain voltage to Vt2 or less, it goes to a second breakdown region and a thermal runway process starts. As the current is continuously increased to a certain voltage, melting occurs in a part of the device, whereby the device can be broken down.

Generally, an NMOS transistor tends to conduct the current irregularly. As shown in FIG. 3, if the second breakdown voltage Vt2 is smaller than the snapback voltage Vt1 the NMOS finger that firstly conducts may be broken down due to a second breakdown before the ESD stress is distributed to other fingers. In this case, the ESD characteristic cannot be improved even if the number of fingers is increased.

### SUMMARY OF THE INVENTION

One aspect of the present invention is to provide an electrostatic discharge protecting circuit using a flash cell, comprising: a plurality of flash cells connected between an I/O pad and a VSS line, a gate of each flash cell being connected to the I/O pad; and a resistor connected between a floating gate of each flash cell and the VSS line.

In the aforementioned of a method for manufacturing an electrostatic discharge protecting circuit according to another embodiment of the present invention, the resistor is formed by a poly or a junction.

In the aforementioned of a method for manufacturing an electrostatic discharge protecting circuit according to another embodiment of the present invention, the plurality of flash cells are arranged and formed in a finger type.

### BRIEF DESCRIPTION OF THE DRAWINGS

The aforementioned aspects and other features of the present invention will be explained in the following description, taken in conjunction with the accompanying drawings, wherein:

FIG. 1 is a circuit diagram showing a conventional electrostatic discharge protecting circuit;

FIG. 2 is a layout showing a conventional electrostatic discharge protecting circuit in a finger type;

FIG. 3 is a graph for explaining an electrical characteristic of the circuit shown in FIG. 1; and

FIG. 4 is a circuit diagram showing an electrostatic discharge protecting circuit according to the present invention.

### DETAILED DESCRIPTION OF PREFERRED EMBODIMENTS

The present invention will be described in detail by way of the preferred embodiment with reference to the accompanying drawings, in which like reference numerals are used to identify the same or similar parts.

FIG. 4 is a circuit diagram showing an electrostatic discharge protecting circuit using a flash cell according to the present invention.

A flash cell 300 is connected between an I/O pad 100 and a VSS line. A gate of the flash cell is connected to the I/O pad 100, and a floating gate of the flash cell is connected to the VSS line 200 through a resistor R. The resistor R can be formed by a poly or a junction. The flash cell includes a source and a drain formed on a semiconductor substrate. A tunnel oxidation film, the floating gate, a dielectric film, and a control gate (hereinafter, referred to as “gate”) are formed above a semiconductor substrate on which the source and drain are formed in advance. The dielectric film is typically made of an ONO film. The ONO film in the flash cell functions as a capacitor, and the floating gate functions as a conventional NMOS transistor.

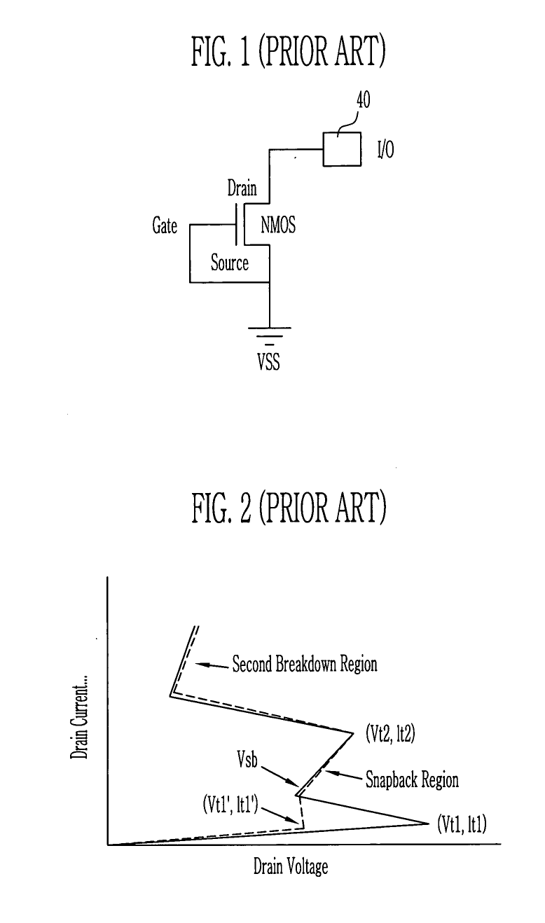

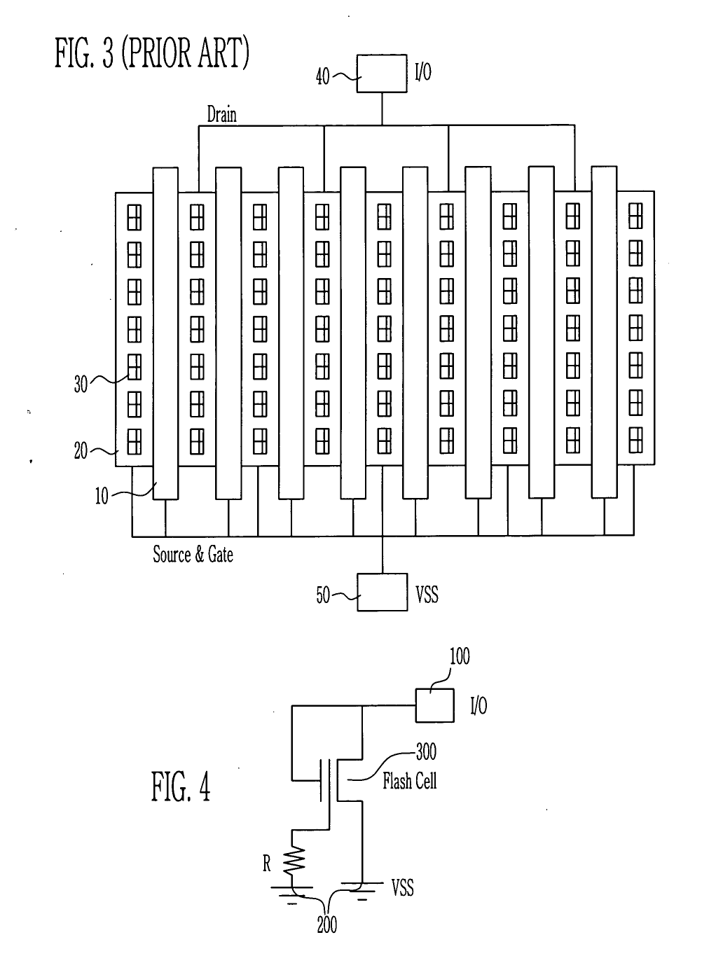

Such flash cells are constructed in a finger type to constitute an electrostatic discharge protecting circuit of which the layout is similar to that of FIG. 2.

Now, the operation of the electrostatic discharge protecting circuit according to the present invention will be described.

When a high external bias is applied to the drain by an ESD stress, a large amount of charges are coupled to the resistor R, and each floating gate on the finger is slightly turned on by the external bias. Since the floating gate is slightly turned on, the snapback voltage is lowered.

Furthermore, several cells among the flash finger cells are not led to the breakdown region until all the other finger cells experience the snapback.

Therefore, the ESD characteristic is improved due to the regular current distribution. Also, the resistance of the resister R and the size of the charge coupling capacitor, that is, the size of the flash cell are determined by an ESD target voltage and a gate turn-on voltage.

According to the present invention, it is possible to improve the ESD characteristic by providing regular current passages against charges generated from a high voltage and device reliability by obtaining a high ESD level.

The present invention has been described with reference to specific exemplary embodiments thereof. It will, however, be evident that various modifications and changes may be made thereto without departing from the broader scope and spirit of the invention as set forth in the appended claims. The specification and drawings are, accordingly, to be regarded in an illustrative rather than in a restrictive sense.

What is claimed is:

1. An electrostatic discharge protecting circuit using a flash cell, comprising:
a plurality of flash cells connected between an I/O pad and a VSS line, a gate of each flash cell being connected to the I/O pad; and
a resistor connected between a floating gate of each flash cell and the VSS line.

2. The electrostatic discharge protecting circuit using a flash cell according to claim 1, wherein the resistor is formed by a poly or a junction.

3. The electrostatic discharge protecting circuit using a flash cell according to claim 1, wherein the plurality of flash cells are arranged and formed in a finger type.
